(19) United States
(12) Patent Application Publication
(10) Pub. No.: US 2003/0207136 A1
(43) Pub. Date: Nov. 6, 2003

(54) Highly transparent thermoformable polyamide film

(76) Inventors: Holger Eggers, Walsrode (DE); Andreas Gasse, Walsrode (DE); Rudi Klein, Walsrode (DE)

Correspondence Address: NORRIS MCLAUGHLIN & MARCUS, P.A., 220 East 42nd Street, 30th Floor, New York, NY, 10017, US

(21) Appl. No.: 09/811,024

(22) Filed: Mar. 16, 2001

(30) Foreign Application Priority Data
Mar. 23, 2000 (DE) 10014371.7

(51) Int. Cl. B32B 27/06; B32B 27/34

(52) U.S. Cl. 428/474.7

(57) ABSTRACT

Described is a thermoformable film comprising at least one layer (I) of polyamide containing solid anisotropic fillers (A) and individual spherulites. The anisotropic fillers (A) of the layer (I) of the thermoformable film, in a number-weighted average of all the dispersed constituents of the anisotropic fillers (A), have a dimension of no more than 10 m in at least one first direction (r1) freely selectable for each dispersed constituent and, in at least one second direction (r2) perpendicular to the first direction (r1), have a dimension of at least 50 times the dimension in the first direction (r1). The individual spherulites in the layer (I) have a number-average distance from each other of no more than 50 nm, and the cores of a majority of the individual spherulites in the layer (I) are free of a filler particle of the anisotropic fillers (A). Also described is a method of preparing the thermoformable films of the present invention, and methods of using the films for, for example, packaging foodstuffs.

### FIELD OF THE INVENTION

The present invention relates to a flexible film containing polyamide comprising at least one layer of polyamide which contains nanoscale, anisotropic fillers having a nucleating action, which film is produced by a film production process which provides very rapid cooling, but do not act as crystallisation nuclei. The polyamide layer is distinguished by an extremely microcrystalline structure. In addition to excellent optical appearance, the film according to the invention exhibits very good thermoformability. The present invention also relates to the use of the thermoformable polyamide film as a packaging material for foodstuffs.

### BACKGROUND OF THE INVENTION

Films containing polyamide are widely used, inter alia in packaging foodstuffs. Advantages of the material polyamide are elevated mechanical strength, good barrier properties towards oxygen, carbon dioxide and other non-polar gases combined with elevated resistance to heat and to scratching.

One feature of central significance to film function for packaging applications is attractive optical properties. Elevated gloss and low haze are required of the film containing polyamide.

Foodstuffs are frequently packaged in thermoform/fill/seal machines, which are also known as thermoforming machines, in blister packages comprising a thermoformed blister film and a smooth fed lidding film. After thermoforming and insertion of the contents into the resultant blister, the two films are bonded together by heat-sealing to form a sealed container. The mode of operation of such machines and the structure of films preferably processed on such machines are known, for example, from The Wiley Encyclopedia of Packaging Technology (eds. M. Bakker, D. Eckroth; John Wiley & Sons, 1986) and in Nentwig (Joachim Nentwig, Kunststoff-Folien, Carl Hanser Verlag 1994, Munich).

One important requirement with regard to the thermoforming behaviour of the film is homogeneous elongation of the film in the thermoformed areas. In many cases, this is not achieved, but instead a structure, hereinafter designated as a thermoforming anomaly, is formed during thermoforming, which structure comprises immediately adjacent thick and thin zones with an abrupt transition from one to the other. The thick and thin zones may be repeated several times in succession, such that the optical appearance of the package is lastingly degraded. This effect has been described in the literature in relation to elongation testing, for example in Kohan, Nylon Plastics Handbook, Hanser Verlag, 1995, pp. 296 et seq. and is termed therein “narrowing” or “necking”. The more pronounced is the yield point of the polyamide, the more distinct is this phenomenon. Nucleation here increases the yield point for both PA6 and PA66 and would thus be expected to increase the tendency towards the thermoforming anomaly.

Experience has shown that the unwanted phenomenon of the thermoforming anomaly may be countered by using copolyamides. In many cases, however, copolyamides are undesirable. They exhibit, for example, a greater tendency to block and a lower thermal stability than polyamide 6 and, not least due to the more complex starting materials and production processes, are more costly than homopolyamides.

Experience has furthermore shown that flat films exhibit the phenomenon of the thermoforming anomaly more frequently and more distinctly than do blown films. In many cases, however, the flat film process is preferred over the blown film process on economic grounds. The output rate of flat film plants is accordingly often distinctly higher and the production costs correspondingly lower than for comparable blown film plants.

In many applications, it is of vital significance that the film may be formed as extremely as possible, i.e. very high forming depths may be achieved. This property is hereinafter denoted “maximum thermoforming value”. A quantitative measure is explained in relation to the evaluation of the Examples. With a given mold format, the maximum thermoforming value is upwardly limited by the film bursting during forming.

Polyamide is a partially crystalline thermoplastic polymer. The structure of the polyamide which is established in a film is here largely dependent upon processing conditions and upon the composition of the polyamide.

The slower the polyamide cooling rate is, the larger are the crystalline structures which may form by crystallisation. The larger these structures are, the more they disrupt the optical appearance of the film. Coarsely crystalline PA films thus exhibit undesirably high haze and an equally undesirably low gloss.

In contrast, in the case of rapid cooling from the melt, only inadequate crystallinity is formed due to polyamide's comparatively slow crystallisation in contrast with other thermoplastics. Incompletely crystallised film is difficult to control in the production process due to its inadequate strength and elevated tendency to adhere. Adhesion occurs, for example, on rolls, especially heated rolls such as for example the laminating roll, which are conventionally operated at relatively high temperatures. Due to the softness of the amorphous film, it extends locally to a variable extent as it detaches from such rolls, so degrading flatness.

It has been known for a relatively long period to add solid particles of the size range of below one micrometre to polymeric matrices and especially polyamides. Such systems are described in concentrations of between approx. 0.3 and 10 wt. %. Advantages achieved at relatively high contents include increased stiffness due to the reinforcing action of the fillers and, in the case of a lamellar structure of the fillers used, also increased oxygen barrier properties due to extended diffusion pathways through the polymeric matrix. Phyllosilicates are in particular used in this connection, which, by means of suitable treatment, may be incorporated into the polyamide matrix in a form digested into lamellae.

EP-A 358415 discloses a film of a polyamide resin with a phyllosilicate uniformly dispersed therein, wherein the individual layers of the phyllosilicate may exhibit thicknesses of around 1 nm and side lengths of up to 1 μm. The layers are present in the polyamide matrix in a form separated by a suitable digestion. Films produced with this material having a phyllosilicate concentration of between 1.2 and 6.5 wt. % are distinguished relative to those made from pure polyamide 6 by distinctly increased oxygen barrier properties and stiffness. Surface slip properties are improved. The transparency of single-layer, amorphously quenched flat films and of water-cooled blown films with the structure polyamide//coupling agent//PE-LD remains unchanged in comparison with pure polyamide 6. The Examples described of PA6 films with a graduated content of phyllosilicate reveal the significant decrease in flex crack resistance and increase in stiffness which occurs in the range up to 3.0 wt. % silicate.

WO 93/04118, together with WO 93/11190 and WO 93/04117, all from the same applicant, disclose a polymer/nano composite which also has lamellar particles of the thickness range of a few nanometres, which are obtained by incorporation not by polymerisation but by mechanical means. In particular, composites of PA6 and montmorillonite or of PA6 and silicates are described with a filler content of between 0.27 and 9 wt. % . However, measurements on bars of the corresponding material still reveal no increase in flexural strength at a silicate content of 0.27%. These materials may also be converted into films. In this case, parallel alignment of the lamellar particles to the film surface is advantageous. Applications as a single-layer film and the possibility of producing multilayer films are described. The films produced from this material may here optionally be stretched in order achieve still better orientation of the nanoparticles. The principal advantage of such films over those without nanoscal particles is higher stiffness, which is, however, always accompanied by distinctly reduced extensibility. This latter phenomenon is undesirable for use as a thermoforming film.

EP-A 818508 discloses a mixture of 60-98% PA MXD6 with 2-40% of an aliphatic polyamide which in turn contains inorganic particles of the nanometre size range. Mixtures are in particular described with PA 6 as the aliphatic polyamide. Multilayer films are furthermore described as moldings which may be produced therefrom. All the stated structures exhibit the advantage of elevated oxygen barrier properties, which are not impaired by sterilisation. In comparison with a flat film of pure PA 6, a film according to the invention with the structure PA 6//(80% PA MXD6+20% PA 6 with nanoparticles)//PA6 exhibits no appreciable improvement in transparency. The principal disadvantage of such structures having an elevated content of PA MXD6 is again the material's low flex crack resistance and puncture resistance.

EP-A 810259 also describes a polyamide molding composition with nanodisperse fillers. The barrier action of the polyamide desired in said document may be improved by the addition of sufficiently finely divided oxides, oxide hydrates or carbonates. The particles preferably have a diameter of less than 100 nm and are used in concentrations of 0.1 to 10 wt. % , preferably of between 1 and 3 wt. % . The patent also describes multilayer films having at least one layer made from this molding composition in order to improve oxygen barrier properties. However, the optical properties of a film made from a polyamide 6 filled with 1 wt. % silicate are significantly degraded in comparison with the system to which the additive has not been added. Elongation at break is also impaired and the tensile modulus is reduced.

### SUMMARY OF THE INVENTION

Against the background of the prior art, the object arose of providing a flexible thermoforming film containing polyamide which combines outstanding optical properties with very good thermoformability, in particular without the occurrence of a thermoforming anomaly in the form of alternating thin and thick bands.

In accordance with the present invention, there is provided a thermoformable film comprising at least one layer (I) of polyamide containing solid anisotropic fillers (A) and individual spherulites, wherein said anisotropic fillers in said layer have in at least one first direction (r1) a size expressed as the number-weighted average size for all of the dispersed components of the fillers, of no more than 10 nm and in at least one second direction (r2) perpendicular to said first direction (r1) a size of at least 50 times the size in the first direction (r1), the number-average distance between the individual spherulites in said layer, is no more than 50 nm, and the cores of the majority of the spherulites do not consist of an anisotropic filler particle.

In an embodiment of the present invention, the fillers (A) are preferably so firmly anchored in layer (I) that, when layer (I) is cooled from the completely molten state at a cooling rate of between 10° and 20° C. per minute, crystalline structures are formed which proceed from the surface of the fillers (A).

In further accordance with the present invention, there is also provided a process for producing a flat thermoformable film comprising at least one layer of polyamide containing solid anisotropic fillers, comprising:

(a) forming a polymer melt;

(b) shaping the polymer melt through a slot die; and

(c) cooling and solidifying the polymer melt, to form a solid film, on a rotating roll which has a temperature of at most 70° C., over a period of at least 0.1 seconds.

Other than in the operation examples, or where otherwise indicated, all numbers expressing quantities of ingredients, reaction conditions, and so forth used in the specification and claims are to be understood as modified in all instances by the term “about.”

### DETAILED DESCRIPTION OF THE INVENTION

The content of anisotropic fillers (A) in layer (I) is preferably between 0.01% and 4% by weight, based on the total weight of layer (I), more preferably between 0.05% and 1.0% by weight, based on the total weight of layer (I), and still more preferably between 0.1% and 0.5% by weight, based on the total weight of layer (I).

Elevated anisotropic filler contents substantially facilitate production of the film on flat film plants in that sufficient strength is imparted to the film even in the case of rapid cooling. At anisotropic filler contents of above approximately 1.0 wt. % , how-ever, the maximum forming depth of the film is low. At excessively low anisotropic filler contents, the film becomes too soft and may no longer be passed through production machinery, in particular over heated rolls, reliably and without extending and suffering subsequent degradation of flatness.

Isotropic or insufficiently anisotropic fillers do not give rise to the desired improvement with regard to reliable production of the film.

The film according to the present invention may contain, in addition to layer (I), one or more further layers containing polyamide. A further layer containing polyamide is preferably characterised in that the fillers (A) in layer (I), in a number-weighted average of all the dispersed constituents of the fillers (A), have a dimension of no more than 10 nm in at least one direction (r1) freely selectable for each dispersed constituent and, in at least one other direction perpendicular to (r1), have a dimension of at least 50 times the dimension in direction (r1), the individual spherulites in layer (I) have a number-average distance from each other of no more than 50 nm and the core thereof, in a numerically predominant proportion of all the spherulites, is not constituted by a filler particle (A), the fillers (A) are so firmly anchored in layer (I) that, when layer (I) is cooled from the completely molten state at a cooling rate of between 10° and 20° C. per minute, crystalline structures are formed which proceed from the surface of the fillers (A), that the content of the fillers (A) in layer (I) is preferably between 0.01% and 4%, relative to the total weight of layer (I).

Layer (I) and optionally present further layers containing polyamide may contain conventional additives.

In a preferred embodiment of the film according to the present invention, layer (I) forms an outer layer. In such an embodiment, layer (I) preferably contains known solid inorganic particles which protrude from the surface of the layer (I) and consequently improve the surface slip behaviour of the film as antiblocking agents. Silicon oxide, calcium carbonate, magnesium silicate, aluminium silicate, calcium phosphate, talcum and the like are suitable for this purpose. Of these, silicon dioxide is preferably used. Effective quantities are in the range from 0.1 to 4 wt. % , preferably from 1 to 2 wt. % . Average particle size is between 1 and 10 μm, preferably 2 and 7 μm, wherein particles of a spherical shape are particularly suitable in this case. Other additives which improve the surface slip of layer (I), also in conjunction with the stated solid particles known as antiblocking agents, are higher aliphatic acid amides, higher aliphatic acid esters, waxes, metal soaps and polydimethylsiloxanes conventionally designated lubricants. The effective quantity of lubricant is in the range from 0.01 to 3 wt. % , preferably 0.02 to 1 wt. % . The addition of higher aliphatic acid amides in the range from 0.01 to 0.25 wt. % is particularly suitable. One aliphatic acid amide which is in particular suitable for polyamide is ethylenebisstearylamide.

Layer (I) together with the optionally present further layers containing polyamide preferably contain no further thermoplastic materials other than polyamide. The polyamide which constitutes layer (I) together with the optionally present further layers containing polyamide preferably contains in each case a mixture of various polyamides comprising at least 90 wt. % polyamide 6 or a copolyamide comprising at least 90 wt. % of units formed from 6-caprolactam. Apart from polyamide 6, polyamides may be selected from the group comprising polyamide 10, polyamide 12, polyamide 66, polyamide 610, polyamide 6I, polyamide 612, polyamide 6/66, polyamide 6I/6T, polyamide MXD6, polyamide 6/6I, polyamide 6/6T, polyamide 6/IPDI or other aliphatic or aromatic homo- and copolyamides or mixtures thereof. It is particularly favourable to use no further polyamide other than polyamide 6 in layer (I) and in the optionally present further layers containing polyamide.

A preferred structure of layer (I) is one in which the spherulites are as small as possible and do not emanate from the surface of the anisotropic particles dispersed in layer (I). Transcrystalline zones, in particular when they proceed from the surface of the anisotropic particles dispersed in layer (I), prove to be unfavourable both to homogeneous thermoforming without the occurrence of a thermoforming anomaly and to an elevated maximum thermoforming value. A crystallite size in a number-weighted average of all crystallites of at most 25 nm is preferred. The cores of at least 51% of the individual spherulites in the layer donot consist of a filler particle, based on the total member of spherulites in the layer.

In order to facilitate heat-sealability, the film according to the invention may contain a single-layer or multilayer sealing layer on an outer side of the multilayer film. The sealing layer accordingly forms the internal side, facing towards the package contents, of the multilayer film. The sealing layer preferably contains the polymers or mixtures of polymers conventionally used as a sealing medium from the group comprising copolymers of ethylene and vinyl acetate (E/VA), particularly preferably having a vinyl acetate content, relative to the total weight of the polymer, of at most 20%, copolymers of ethylene and unsaturated esters such as butyl acrylate or ethyl acrylate (E/BA and E/EA respectively), copolymers of ethylene and unsaturated carboxylic acids (E/AA, E/MAA), particularly preferably having a content of the carboxylic acid comonomer, relative to the total weight of the polymer, of at most 15%, still more preferably of at most 8%, salts of the copolymers of ethylene and unsaturated carboxylic acids, in particular E/MAA, (ionomers), particularly preferably having a content of the carboxylic acid comonomer, relative to the total weight of the ionomer, of at most 15%, still more preferably of at most 10%, low density polyethylene (PE-LD), particularly preferably of a density of at least 0.91 g/cm³ and at most 0.935 g/cm³, high density polyethylene (PE-HD), copolymers (PE-LLD) of ethylene and α-olefins having at least 3 C atoms, for example butene, hexene, octene, 4-methyl-1-pentene. The copolymers (PE-LLD) of ethylene and α-olefins may be produced with conventional catalysts or with metallocene catalysts. Of these, co-polymers (PE-LLD) of ethylene and x-olefins having a density of at least 0.90 g/cm³ and at most 0.94 g/cm³ are particularly preferred.

In addition to layer (I) and the optionally present further layers containing polyamide and optionally in addition to the sealing layer, the multilayer film according to the invention may also contain one or more layers containing EVOH in order to improve oxygen barrier properties, wherein the layers containing EVOH preferably contain at least 50 wt. % , relative to the total weight of the particular layer containing EVOH, of an EVOH comprising at least 40 and at most 85 mol % vinyl acetate, which is at least 90% saponified. A layer containing EVOH is particularly preferably located between two layers containing polyamide.

In addition to layer (I) and the optionally present further layers containing polyamide, the sealing layer and/or one or more layer(s) containing EVOH, the multilayer film according to the invention may contain one or more coupling layers. Such a coupling layer is preferably a laminating adhesive based on polyurethanes or polyesterurethanes or an extrudable coupling agent.

In addition to layer (I) and the optionally present further layers containing polyamide, the sealing layer, one or more layer(s) containing EVOH and/or one or more coupling layer(s), the multilayer film according to the invention may contain still further polymeric layers.

The multilayer film according to the invention may preferably be produced on flat film plants. It is possible in this connection to coextrude all or some of the layers, i.e. the polymers of these layers are brought together as melt streams and passed through a common die in molten form.

It is favorable to produce layer(s) (I) together with optionally present further layers containing polyamide as a flat film. Further layers, in particular the layers containing EVOH, may additionally be produced by coextrusion with layer (I) and optionally present further layers containing polyamide.

In order to obtain the structure of layer (I) of the film according to the invention, the melt containing this layer must be rapidly cooled after extrusion.

In the flat film process, this may be achieved by sufficiently low casting roll temperatures; temperatures of below 70° C. being preferred and of 50° C. being further preferred. Residence times of at least 0.1 second should be maintained in this case.

The cooling required to obtain the structure may be achieved in the tubular film process by quenching the melt in a liquid bath or in contact with liquid-wetted surfaces or in contact with flowing liquids. Water is preferably used as the temperature control medium. Liquid temperatures of below 40° C. are favourable, preferably of below 30° C. Residence times of at least 0.1 second should be maintained in this case.

The multilayer film according to the invention may be provided on the outside or between two internal layers with a layer of a metal, preferably aluminium, an oxide of a metal or a non-metal, preferably an oxide of silicon, iron or aluminum. This layer preferably has a thickness of 5 to 200 nm. Due to the smooth surface of these layers, a coating on a layer (I) is preferably provided such that the coating is not on the outside of layer (I). In laminated composites, it is favourable to provide a coating on the side of a layer (I) immediately adjacent to the laminating adhesive.

The film according to the invention may be printed on the outside, the inside or between individual layers. Printing is preferably on a layer (I), in particular in such a form that the coating is not on the outside of layer (I). In laminated composites, it is favourable to provide a coating on the side of a layer (I) immediately adjacent to the laminating adhesive.

It has surprisingly been found that the film according to the invention achieves very good thermoformability with uniform drawing without the occurrence of a thermoforming anomaly. The film additionally exhibits an elevated maximum thermoforming value.

Surprisingly, the film may also reliably be produced in particular on flat film plants, so permitting optimum utilisation of operating resources.

This result is also unexpected from the standpoint that the good production characteristics are not attributable to the existing and very marked nucleating action of the nanoscale fillers used. Instead, the crystallite structure has formed independently of the dispersed particles in the matrix surrounding said particles. The presence of the particles is nevertheless indispensable from the production standpoint. In particular, even small contents of the particles are surprisingly highly effective.

The range of properties achieved by the film according to the invention make it particularly suitable for use as a thermoforming film and, in conjunction with a sealing layer, in particular for packaging purposes.

The film according to the invention additionally exhibits an outstanding optical appearance. The present invention accordingly also in particular provides the use of the film for packaging foodstuffs.

The present invention is more particularly described in the following examples, which are intended to be illustrative only, since numerous modifications and variations therein will be apparent to those skilled in the art. Unless otherwise specified, all parts and percentages are by weight.

### EXAMPLES

The following properties were determined as follows in the Examples according to the present invention, and the Comparative Examples.

1) Examination of a cross-section of the film by transmission electron microscopy. A thin cross-section of the polyamide outer layer of the film is taken and a formaldehyde solution and OsO₄ are added thereto as contrasting agents. The structure was characterised as follows using a 15000;1 magnification print-out:

It is determined whether a substantially spherulitic crystal structure (that does not emanate from the nanoscale anisotropic particles) is present.

The number-weighted average distance between the spherulites is determined where the structure is substantially spherulitic.

2) Feasibility of production as a flat film under the stated conditions. Film stability was in particular assessed. Stability in this case means that the film can to be passed through the plant without adhering and over-stretching and that the film is windable. The film web tension in combination with the local rate of elongation were used for this purpose. Web tension here means the force exerted by the film during running production on a force-measuring roll. The rate of elongation is taken to mean the advance between two roll pairs which define film speed, scaled against the absolute peripheral speed of the roll which measures web tension. Elevated web tension at a low rate of elongation means a stable film. Low web tensions or an elevated rate of elongation are synonymous with a soft, unstable film.

Thermoformability was evaluated on an Alfa Laval Tiromat 3000 model thermoforming machine. The films were processed at a thermoforming temperature of 90° C.; heating was provided by contact with an appropriately temperature-controlled hot plate. The heating and forming time were each 3 seconds. Blister size was 184 mm×114 mm (length×width). The maximum thermoforming value was determined as the mold depth at which in excess of 90% of all blisters could still be produced without bursting. Mold depth was here varied in 5 mm steps by inserts of varying thicknesses in the mold. The blisters thermoformed at a mold depth of 60 mm were moreover assessed qualitatively with regard to the occurrence of thermoforming anomalies.

The following ratings are used:

+: no or slightly discernible bands in one area of the blister;

o: clearly discernible bands in one area of the blister; and

−: highly visible bands in one area of the blister.

Haze was determined in accordance with ASTM D 1003.

Test Series 1:

### Comparative Example V 1.1 and V 1.2

Single-layer flat films of polyamide 6 of a thickness of 50 μm were produced on a flat film plant of conventional design. The casting roll has a peripheral speed of 20 m/min. The contact time of the film on the casting roll was approx. 3 seconds. The following cooling roll was set to the same temperature as the casting roll. The width of the films was 460 mm. The polyamide 6 used contains 600 ppm of ethylenebisstearylamide and approx. 150 ppm of talcum as nucleating agent. It exhibits a relative solution viscosity of 3.8 in m-cresol. The temperature of the casting roll was varied within the test series.

In Comparative Example 1.1 (V1.1), the casting roll temperature was 100° C.

In Comparative Example 1.2 (V1.2), the casting roll temperature was 20° C.

The results for test series 1 are summarised in the following table:

Comparative Example (V)
PA6, 50 μm

| Feature *unit) | V1.1 | V1.2 |
|---|---|---|
| Casting roll temperature (° C.) | 100 | 20 |
| Haze (%) | 5.8 | 0.4 |
| Spherulitic structure? | yes | Yes |
| Average spherulite spacing (nm) | 2000 | 20 |
| Web tension (N) | 68 | 14 |
| Rate of elongation (%) | <1% | 4.3% |
| Maximum thermoforming value (mm) | 80 | 85 |
| Thermoforming anomaly (rating) | − | + |

While the polyamide film V1.1 produced with a hot casting roll proves not to be thermoformable without necking, film V1.2 produced with a cold chill roll is too soft on the production plant.

Test Series 2:

### Example B 2.4

Flat films were produced under the conditions of Comparative Examples V1.1 and V1.2. The polyamide used was polyamide 6 filled with 2 wt. % of an inorganic, anisotropic filler.

### Comparative Examples V2.1 and V2.2

The filler used in Comparative Examples 2.1 and 2.2 was lamellar mica having an average particle diameter of 25 μm and an average thickness of 0.5 μm. The mica was dispersed in the polyamide in a twin-screw extruder, the extrudate was then pelletised, blended with unfilled polyamide 6 and converted into a flat film.

### Comparative Examples V2.3 and V2.4

In Comparative Examples 2.3 and 2.4, a polyamide with a relative solution viscosity of 3.6 in m-cresol was used which, in contrast, contained 2 wt. % of nanoscale, lamellar-dispersed phyllosilicate (montmorillonite). The montmorillonite particles are approx. 1 nm thick and 100 to 1000 nm in diameter and are thus substantially more finely dispersed that the fillers used in Comparative Examples 2.1 and 2.2.

Comparative Examples 2.1 and 2.3 were produced with a casting roll temperature of 100° C. and Comparative Example 2.2 and Example 2.4 with a casting roll temperature of 20° C.

Characterization of the films revealed the result summarized in the following table:

| | Example (B) or Comparative Example (V) | | | |
|---|---|---|---|---|
| | PA6 with 2% filler, 50 μm | | | |
| Feature (unit) | V2.1 | V2.2 | V2.3 | B2.4 |
| Casting roll tem- | 100 | 20 | 100 | 20 |
| perature (° C.) | | | | |
| Filler | 2% mica | 2% mica | 2% mont- | 2% mont- |
| | | | morillonite | morillonite |
| Haze (%) | 9.8 | 7.4 | 2.0 | 1.8 |
| Spherulitic cry- | yes | yes | no, transcrys- | yes |
| stallite structure? | | | talline from | |
| | | | filler surface | |
| Average spherul- | 2000 | 20 | — | 20 |
| ite spacing (nm) | | | | |
| Web tension (N) | 71 | 19 | 94 | 76 |
| Rate of elonga- | <1% | 4.1% | <1 | <1 |
| ation (%) | | | | |
| Maximum ther- | 80 | 80 | 65 | 70 |
| moforming value | | | | |
| (mm) | | | | |
| Thermoforming | ∘ | + | − | + |
| anomaly (rating) | | | | |

While the samples produced with a cold casting roll exhibit thermoforming without necking, the samples V2.1 and V2.3 produced with a hot casting roll exhibit a distinct thermoforming anomaly, which is considerable in the case of the PA6 filled with montmorillonite. Comparative Example 2.3 in particular additionally exhibits deficiencies with regard to the maximum thermoforming value. Comparative Example B2.2, similarly to quenched, unfilled PA6, is too soft on the production plant. Example 2.4 proves highly suitable in all properties.

Test series 3:

Examples B3.1 to B3.3:

The content of montmorillonite was varied on the basis of Example 2.4, i.e., using a cold casting roll. To this end, the polyamide 6 containing 2% montmorillonite from Example 2.4 was blended with the unfilled polyamide 6 from test series 1 in such a manner that montmorillonite contents in the mixture of 0.2%, 0.4% and 1.0 wt. % are obtained. The films are respectively designated in this order Examples 3.1, 3.2 and 3.3. Characterisation of the films revealed the result shown in the following table. This Table also contains the data of Comparative Example V1.2 and Example B2.4.

| | Example (B) or Comparative Ex- | | | | |
|---|---|---|---|---|---|
| | ample (V) PA6 with digested- | | | | |
| | montmorillonite, 50 μm | | | | |
| Feature (unit) | V1.2 | B3.1 | B3.2 | B3.3 | B2.4 |
| Casting roll temperature (° C.) | 20 | 20 | 20 | 20 | 20 |
| Montmorillonite filler content (wt. %) | 0 | 0.2 | 0.4 | 1.0 | 2.0 |
| Haze (%) | 0.4 | 0.7 | 1.1 | 1.3 | 1.8 |
| Spherulitic crystallite structure? | yes | yes | yes | yes | yes |
| Average spherulite spacing (nm) | 20 | 20 | 20 | 20 | 20 |
| Web tension (N) | 14 | 31 | 67 | 79 | 76 |
| Rate of elongation (%) | 4.3% | <1 | <1 | <1 | <1 |
| Maximum thermoforming value | 85 | 80 | 75 | 75 | 70 |
| (mm) | | | | | |
| Thermoforming anomaly (rating) | + | + | + | + | + |

Examples B3.1 to B3.3 prove to be well suited in all respects. In particular, in comparison with Example B2.4, they constitute a further improvement with regard to the maximum thermoforming value.

Although the invention has been described in detail in the foregoing for the purpose of illustration, it is to be understood that such detail is solely for that purpose, and that variations can be made therein by those skilled in the art without departing from the spirit and scope of the invention except as it may be limited by the following claims.

What is claimed is:

1. A thermoformable film comprising at least one layer of polyamide containing solid anisotropic fillers and individual spherulites, wherein, said anisotropic fillers in said layer have in at least one first direction a size, expressed as the number-weighted average size for all of the dispersed components of the fillers, of no more than 10 nm and in at least one second direction perpendicular to said first direction a size of at least 50 times the size in the first direction, the number-average distance between the individual spherulites in said layer is no more than 50 nm, and the cores of the majority of the spherulites do not consist of an anisotropic filler particle.

2. The film of claim 1, wherein said anisotropic fillers are so firmly anchored in said layer that, when said layer is cooled from the completely molten state at a cooling rate of between 10° and 20° C. per minute, crystalline structures are formed which proceed from the surface of said anisotropic fillers.

3. The film of the claim 1, wherein the content of said anisotropic fillers in said layer is from 0.01% and 4% by weight, based on the total weight of said layer.

4. The film of claim 1, wherein the individual spherulites in said layer have a number-average distance from each other of no more than 25 nm.

5. The film of claim 1, wherein it comprises one or more further layers containing polyamide.

6. The film of claim 1, wherein said layer contains polyamide which is formed from at least 90 wt. % ε-caprolactam.

7. The film of claim 1, wherein said layer forms an outer layer of the film.

8. The film of claim 1, wherein said film comprises a single-layer or multilayer heat-sealable sealing layer on an outer side.

9. The film of claim 1, wherein said film further comprises at least one layer containing EVOH.

10. The film of claim 1, wherein said film further comprises,
(i) at least one polymeric layer, or
(ii) a layer of metal, metal oxide or printing, between two layers.

11. The film of claim 1, wherein said layer is a flat film, the production of which comprises:
(a) forming a polymer melt;
(b) shaping the polymer melt through a slot die; and
(c) cooling and solidifying the polymer melt, to form a solid film, on a rotating roll which has a temperature of at most 70° C., over a period of at least 0.1 seconds.

12. A process for producing a flat thermoformable film comprising at least one layer of polyamide containing solid anisotropic fillers, comprising:
(a) forming a polymer melt;
(b) shaping the polymer melt through a slot die; and
(c) cooling and solidifying the polymer melt, to form a solid film, on a rotating roll which has a temperature of at most 70° C., over a period of at least 0.1 seconds.

13. A method of using the film of claim 1 for the production of containers on form/fill/seal machines.

14. A method of using the film of claim 1 for packaging foodstuffs.

15. An article comprising the film of claim 1.
